(19) United States
(12) Patent Application Publication
(10) Pub. No.: US 2026/0095540 A1
(43) Pub. Date: Apr. 2, 2026

(54) NON-TRANSITORY STORAGE MEDIUM STORING PROGRAM WHICH SUPPORTS UNIVERSAL SCAN SOFTWARE, METHOD, AND INFORMATION PROCESSING APPARATUS

(71) Applicant: CANON KABUSHIKI KAISHA, Tokyo (JP)

(72) Inventor: HIROYA YAMAMOTO, Ibaraki (JP)

(21) Appl. No.: 19/321,064

(22) Filed: Sep. 5, 2025

(30) Foreign Application Priority Data
Sep. 13, 2024 (JP) 2024-158731

(51) Int. Cl. H04N 1/60; H04N 1/00

(52) U.S. Cl. CPC H04N 1/6008; H04N 1/00482; H04N 1/00811; H04N 1/6005

(57) ABSTRACT

A method for supporting general-purpose software that is usable in common by a plurality of image processing devices manufactured by different manufacturers includes displaying a display screen configured to accept a dropout color setting which removes a specific color from an image, and outputting a read instruction to cause an image processing device to read an original image according to the dropout color setting accepted through the display screen.

### BACKGROUND

### Field of the Technology

Aspects of the present disclosure generally relate to a storage medium storing a program which supports universal scan software, a method, and an information processing apparatus.

### Description of the Related Art

There is a known configuration which uses a scan driver installed on a host computer as software for controlling a scanning device and issues a scan instruction (read instruction) to the scanning device connected to the host computer. The host computer has an operating system (OS), serving as basic software, installed thereon, and the scan driver is configured according to the specifications specified by the OS and is invoked by the OS to run. The vendor (manufacturer) which provides a scanning device provides a scan driver compatible with the specifications of an OS, thus being able to provide a method or unit for issuing an instruction for scanning to the scanning device with use of the OS.

Recently, in Windows®, a standard class driver (hereinafter also referred to as a “standard driver”) which is able to be used in common by respective scanning devices provided by a plurality of vendors has been about to be provided. Such a standard driver is included in the package of an OS and easily becomes usable by connecting an optional scanning device to a host computer. Therefore, it is not necessary to separately install a device-specific scan driver adapted for the scanning device, so that the standard driver is highly convenient. Moreover, the standard driver is expected to be configured in such a way as to allow designating a scan function according to scan function information generated based on information acquired from the connected scanning device. This enables a user who uses the standard driver to, regardless of currently using one standard driver, designate a scan function corresponding to the capability of the connected scanning device. However, since the designated scan function stays within functions which are feasible only by the standard driver, the user is unable to designate a function specific to a scanning device vendor (manufacturer).

Under such circumstances, Japanese Patent Laid-Open No. 2021-033526 describes a program for extending the print function of universal software.

Here, the function of a scan driver specific to a scanning device vendor includes a dropout color function. The dropout color function is the function of not reading a specific color included in an original to be read. The dropout color function works in such a way as not to read unnecessary printing such as the frame of a business form and, therefore, enables obtaining image data which is easily handled by the user.

However, in a case where the user uses the standard driver, the standard driver does not have the capability of ensuring the use of the dropout color function.

### SUMMARY

Aspects of the present disclosure are generally directed to providing a system that supports universal (general-purpose) scan software, which is commonly usable across image processing devices provided by a plurality of manufacturers, and enables a dropout color function that removes a specific color from an image.

According to an aspect of the present disclosure, a non-transitory computer-readable storage medium storing a program for supporting general-purpose software which is able to be used in common by a plurality of image processing devices manufactured by different manufacturers, wherein the program, when executed by a computer, causes an information processing apparatus to perform a method includes displaying, on a display unit, a display screen to accept a dropout color setting which removes a specific color from an image, and outputting a read instruction to cause an image processing device to initiate reading of an original image according to the dropout color setting accepted through the display screen.

Features of the present disclosure will become apparent from the following description of embodiments with reference to the attached drawings. The following description of embodiments is described by way of example.

### BRIEF DESCRIPTION OF THE DRAWINGS

FIG. 1 is a hardware configuration diagram of a scanning system in a first embodiment.

FIGS. 2A and 2B are software configuration diagrams of the scanning system in the first embodiment.

FIGS. 3A, 3B, and 3C are diagrams illustrating a scan setting screen and advanced setting screens in the first embodiment.

FIG. 4 is a flowchart illustrating editing processing for scan function information, which is performed by an extension application in the first embodiment.

FIG. 5 is a diagram illustrating lists of scan functions of respective devices in the first embodiment.

FIG. 6 is a sequence diagram used to explain a scanning operation in the first embodiment.

FIG. 7 is a flowchart illustrating scan processing in the extension application in the first embodiment.

FIG. 8 is a flowchart illustrating scan processing in a scanning device in the first embodiment.

FIG. 9 is a flowchart illustrating addition processing for a dropout color function in an extension application in a second embodiment.

FIG. 10 is a sequence diagram used to explain a scanning operation in the second embodiment.

FIG. 11 is a flowchart illustrating scan processing in the extension application in the second embodiment.

FIG. 12 is a sequence diagram used to explain a scanning operation in a third embodiment.

FIG. 13 is a sequence diagram used to explain a scanning operation in the third embodiment.

FIG. 14 is a sequence diagram used to explain a scanning operation in a fourth embodiment.

FIG. 15 is a flowchart illustrating scan processing in an extension application in the fourth embodiment.

FIGS. 16A, 16B, 16C, and 16D are diagrams illustrating tables of capability information and advanced setting screens in a fifth embodiment.

FIGS. 17A, 17B, 17C, and 17D are diagrams illustrating tables of capability information and advanced setting screens in a sixth embodiment.

FIGS. 18A, 18B, and 18C are diagrams illustrating tables of capability information and an advanced setting screen in a seventh embodiment.

### DESCRIPTION OF THE EMBODIMENTS

Various embodiments, features, and aspects of the disclosure will be described in detail below with reference to the drawings. Furthermore, the following embodiments should not be construed to limit the present disclosure set forth in claims, and not all of the combinations of features described in the embodiments are essential for solutions in the present disclosure.

### First Embodiment

### <Hardware Configuration of Scanning System>

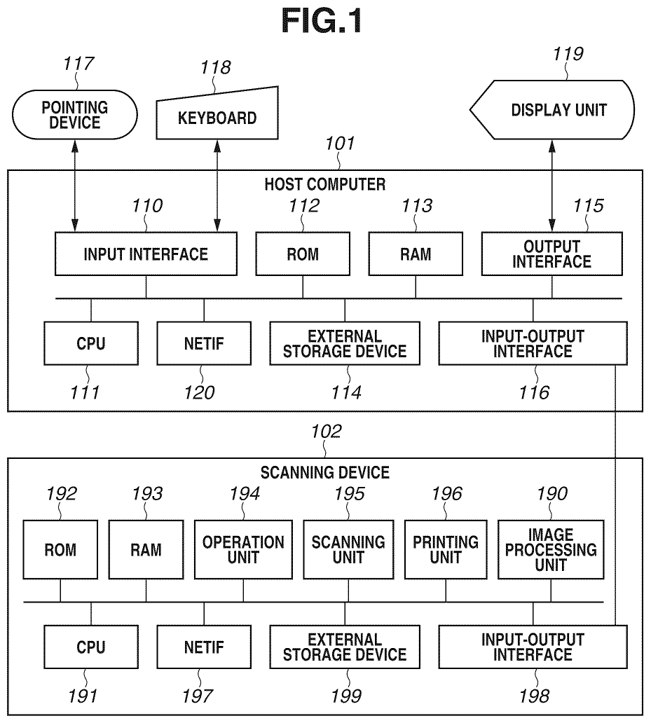

FIG. 1 is a block diagram illustrating a hardware configuration of a scanning system in a first embodiment of the present disclosure.

### <Host Computer>

Referring to FIG. 1, a host computer 101, which is an example of an information processing apparatus, includes an input interface 110, a central processing unit (CPU) 111, a read-only memory (ROM) 112, a random access memory (RAM) 113, an external storage device 114, an output interface 115, an input-output interface 116, and a network interface (hereinafter referred to as an “NETIF”) 120. Moreover, to the input interface 110, input devices, such as a keyboard 118 and a pointing device 117, are connected, and, to the output interface 115, a display device such as a display unit 119 is connected. The NETIF 120 performs control to perform data transfer with external equipment via a network.

An initialization program is stored in the ROM 112.

The external storage device 114 is, for example, a hard disk drive (HDD) or a solid state drive (SSD). An application program group, an operating system (OS), and other various pieces of data are stored in the external storage device 114.

The RAM 113 is used as, for example, a work memory to be used for execution of various programs stored in the external storage device 114, so that the various programs are able to run in the host computer 101.

Furthermore, in the first embodiment, the CPU 111 performs processing according to code of a program stored in the ROM 112, thus executing the respective functions described below in the host computer 101 and performing processing operations illustrated in the respective flowcharts described below.

### <Scanning Device>

A scanning device 102, which is an example of an image processing device, is connected to the host computer 101 via an input-output interface 198 of the scanning device 102 and the input-output interface 116 of the host computer 101. A wired network can be provided or a wireless network can be provided between the input-output interface 198 of the scanning device 102 and the input-output interface 116 of the host computer 101.

The scanning device 102 includes a CPU 191, a ROM 192, a RAM 193, an operation unit 194, a scanning unit 195, a printing unit 196, an NETIF 197, the input-output interface 198, an external storage device 199, and an image processing unit 190.

The CPU 191 comprehensively controls the scanning device 102.

The ROM 192 is a memory which stores a program.

The RAM 193 is a memory which temporarily stores a program and image data.

The scanning unit 195 is a scanner and scans (reads) an image on an original.

The printing unit 196 prints an image on a sheet based on image data. Furthermore, the printing unit 196 is not essential.

The NETIF 197, which is a network interface, performs control to perform data transfer with external equipment via a network. The image processing unit 190 performs various image editing processing operations on input image data.

While, here, the host computer 101 and the scanning device 102 are configured separately from each other, these can also be configured integrally with each other as a single information processing apparatus. Moreover, a scan setting screen and an advanced setting screen each described below are screens to be displayed on the display unit 119. Furthermore, in the first embodiment, the scanning device 102 is described with an electrophotographic-type digital multifunction peripheral, which has a plurality of functions such as copying, printing, and facsimile (FAX), cited as an example. However, the scanning device 102 is not limited to this, and the first embodiment is also applicable to, for example, equipment which uses another process such as an inkjet method or a scanner which performs only image scanning. Moreover, the host computer 101 can be a desktop personal computer, a smartphone, or a notebook personal computer.

### <Software Configuration of Scanning System>

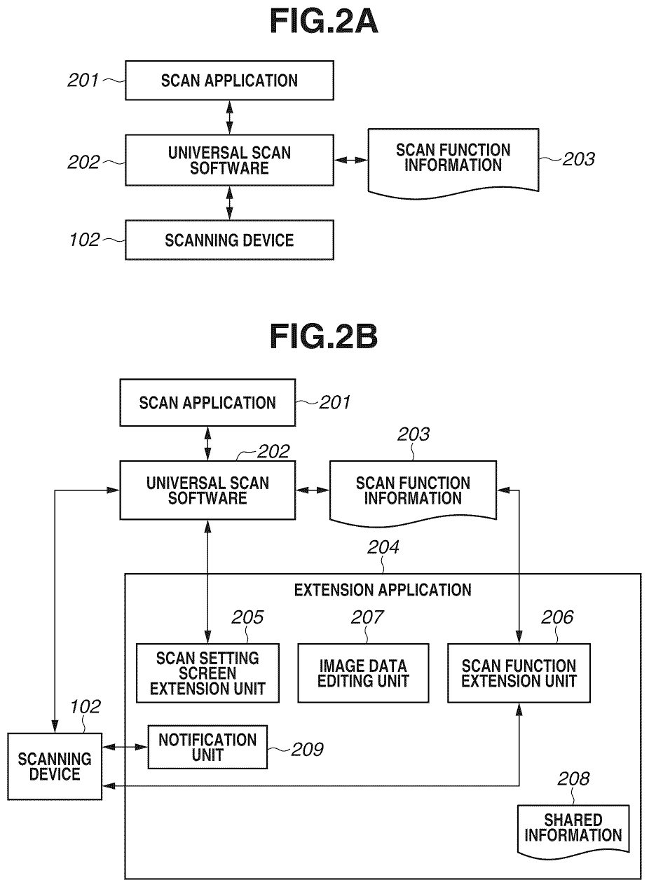

FIGS. 2A and 2B are diagrams each schematically illustrating a software configuration of the scanning system. The software configuration illustrated in FIG. 2A or 2B is stored in the external storage device 114 illustrated in FIG. 1. Here, a scanning system using a host computer 101 loaded with Windows® 11 of Microsoft® serving as an OS is described as a premise. Furthermore, in macOS of Apple, a standard driver is also provided, so that the first embodiment is also applicable to this.

FIG. 2A is a diagram illustrating a general configuration in a case where an extension application 204 is not associated with universal scan software 202 and the scanning device 102.

FIG. 2B is a diagram illustrating a configuration in a case where the extension application 204 is associated with the universal scan software 202 and the scanning device 102.

### <Software Configuration of Scanning System (Extension Application Not Being Associated)>

First, a configuration of the scanning system in a case where the extension application 204 is not associated is described with reference to FIG. 2A.

A scan application 201 is software for taking in content (image data) obtained by scanning. For example, a document creation application or an image editing application is equivalent to the scan application 201. Upon receiving a scan request from the user, the scan application 201 issues a scan instruction (read instruction) to the OS. The scan instruction includes scan setting information for issuing an instruction for operations of the universal scan software 202 and the scanning device 102.

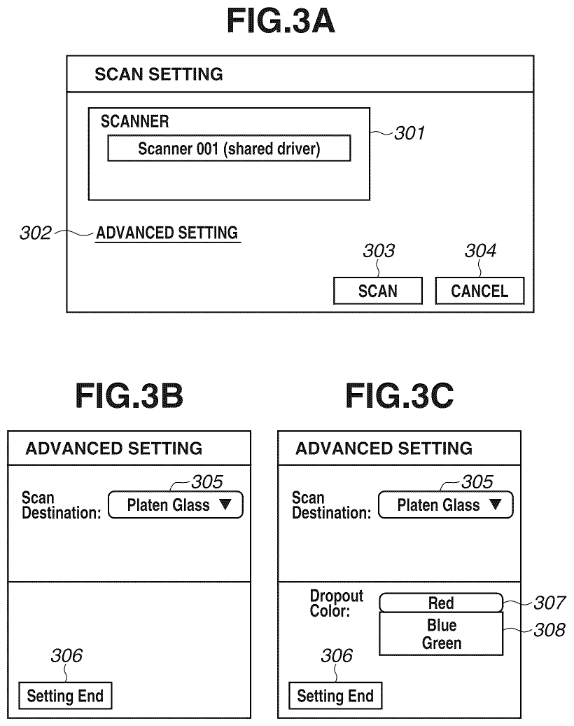

The scan application 201 is able to cause a scan setting screen, which any one of the universal scan software 202, the OS, and the scan application 201 provides, to be displayed to execute the scan instruction. Moreover, in response to an advanced setting button in the scan setting screen being pressed, the universal scan software 202 additionally displays an advanced setting screen. The scan setting screen and the advanced setting screen are described below with reference to FIGS. 3A, 3B, and 3C. The advanced setting screen includes a setting item (hereinafter also referred to as a “control item”) indicating a scan function settable according to capability information (settable information) about the universal scan software 202 and a control item indicating a setting value for the setting function.

The universal scan software 202 determines a scan capability based on scan function information 203.

The scan function information 203 is data indicating all of the settable scan functions, setting values therefor, and scan functions in which an exclusive relationship between the setting values is described. The scan function information 203 is included in a configuration file of the universal scan software 202, and is arranged as a non-modifiable file in the external storage device 114. Alternatively, the scan function information 203 is also able to be dynamically generated by the universal scan software 202.

Specifically, the universal scan software 202 or the OS can be configured to acquire scanning device attribute data from the scanning device 102 and generate the scan function information 203 according to attribute information included in the acquired attribute data. Furthermore, in a case where the scan function information 203 is dynamically generated, the generated scan function information 203 is editable. Furthermore, the scanning device attribute data which is acquired from the scanning device 102 includes attribute information indicating a scan function able to be designated by the scanning device 102 (scanning device capability) and a setting value related to the attribute information. Such information is stored in the RAM 113.

As configured in this manner, the universal scan software 202 can be configured to allow the user to designate a scan function which is available in each scanning device 102 according to the connected scanning device 102. In other words, even in a case where a scanning device having a different function or a scanning device developed by a different vendor has been connected, the universal scan software 202 can be configured to allow the user to designate a scan function which is available according to the connected scanning device. Moreover, the universal scan software 202 is able to generate a scan instruction which is interpretable by a plurality of scanning devices manufactured by the respective different vendors and output the generated scan instruction to each of the plurality of scanning devices manufactured by the respective different vendors. Furthermore, the vendor can be a manufacturer (maker) of the scanning device 102. Furthermore, here, the universal scan software 202 is a standard class driver which performs scanning based on a standard scan protocol called “Mopria”. The universal scan software 202 acquires capability information about the connected scanning device 102 and generates scan function information 203 based on the acquired capability information, in such a way as to allow the user to designate a scan function which is supported by the connected scanning device 102. The universal scan software 202 acquires the scan function information 203 from the scanning device 102 with the Internet Printing Protocol (IPP) and preforms reception of image data generated by the scanning device 102 scanning an original. However, the universal scan software 202 is not compatible with a dropout color function, which is the function of not reading a specific color included in an original to be read. This is because the dropout color function is a function unique to a scanning device vendor (scanning device manufacturer).

### <Dropout Color Function>

The dropout color function is the function of, when scanning an original, without reading a specific color in the original, reflecting the original with the specific color removed therefrom in image data.

The dropout color function works in such a way as not to reflect, for example, the frame of a business form or a red circle put on a test paper in image data and, therefore, enables obtaining image data which is easily handled by the user.

There are some methods capable of implementing the dropout color function. Specifically, there are, for example,
a method of replacing luminance values about a color designated from luminance values of red (R), green (G), and blue (B) of the read image data with a background color,
a method of using unreadable ink with utilization of optical characteristics of the scanning device, and
a method of using a filter which absorbs a specific color, and any one of the methods can be applied to the first embodiment or the first embodiment is not limited to the use of such a method as long as it is possible to implement dropout color.

While, in the first embodiment, the case of causing the user to make a selection from “red”, “green”, and “blue” is described, a configuration in which the user is allowed to select another color can also be employed. Additionally, the method of causing the user to directly designate the luminance values of R, G, and B can also be employed, or a configuration in which the user is allowed to select a plurality of colors can also be employed.

### <Software Configuration of Scanning System (Extension Application Being Associated)>

Next, a configuration of the scanning system in a case where the extension application 204 is associated is described with reference to FIG. 2B. Furthermore, the same constituent elements as those illustrated in FIG. 2A are omitted from description here.

The extension application 204 is software for extending or supporting the function of the universal scan software 202, and is also called a “support application”. The extension application 204 is software which is not preliminarily included in the OS (is not bundled software).

Therefore, the user needs to operate the host computer 101, download the extension application 204 from a server via the Internet, and install the extension application 204 on the host computer 101. Alternatively, the extension application 204 can be automatically installed based on the scanning device 102 having been connected to the host computer 101. Specifically, in a case where the scanning device 102 has been connected to the host computer 101, the OS acquires device identification information from the scanning device 102. The OS can download an extension application 204 corresponding to the acquired device identification information from a server via the Internet and install the extension application 204 on the host computer 101. Thus, the universal scan software 202 and the extension application 204 are retained as respective separate files in the host computer 101.

Furthermore, while the universal scan software 202 and the extension application 204 may be updated to be upgraded in version, this update processing is also performed at respective separate timings. Thus, timing at which the universal scan software 202 is acquired by the host computer 101 and timing at which the extension application 204 is acquired by the host computer 101 differ from each other. Moreover, a trigger with which the universal scan software 202 is acquired by the host computer 101 and a trigger with which the extension application 204 is acquired by the host computer 101 also differ from each other. Furthermore, in a case where the extension application 204 has been installed, the OS associates the extension application 204 with the universal scan software 202 and the scanning device 102.

The extension application 204, which is described in the first embodiment, includes a scan setting screen extension unit 205, a scan function extension unit 206, an image data editing unit 207, and a notification unit 209. Moreover, the extension application 204 further includes shared information 208, which is accessible in common from each unit. The entity of the shared information 208 is files stored in the external storage device 114 or information stored in the RAM 113. The extension application 204 uses an application programming interface (API) provided by the OS to perform writing or reading of information to or from the shared information 208.

Furthermore, the extension application 204 can end an operation thereof each time processing performed by each unit ends. In that case, the OS launches the extension application 204 each time a request for using each unit is received.

Additionally, the extension application 204 can cancel a processing operation thereof during the time when processing is being performed by each unit. In a case where the processing operation has been cancelled, a job which is being processed is cancelled by the OS.

Upon receiving a scan request from the user, the scan application 201 issues a scan instruction to the OS. Even in the present configuration, as with the configuration illustrated in FIG. 2A, the scan application 201 is able to cause a scan setting screen to be displayed. In the present configuration, an advanced setting screen which the extension application 204 provides is displayed. Specifically, an advanced setting screen which the scan setting screen extension unit 205 included in the extension application 204 provides is displayed. Moreover, the scan setting screen extension unit 205 is able to store advanced settings set by the user in the shared information 208.

The extension application 204 includes the image data editing unit 207. The image data editing unit 207 acquires image data from the scanning device 102 and performs editing on the acquired image data. The image data editing unit 207 acquires advanced setting information from the shared information 208, and performs image editing corresponding to the advanced settings on the image data. The image data editing unit 207 can also be configured to acquire image data acquired by the universal scan software 202 and perform image editing corresponding to the advanced settings on the image data. Moreover, even in the configuration illustrated in FIG. 2B, dropout color may not be performed by the user. In that case, as in the configuration illustrated in FIG. 2A, the universal scan software 202 can issue a scan request instruction to the scanning device 102 without via the extension application 204.

The extension application 204 includes the scan function extension unit 206. The scan function extension unit 206 is able to edit scan function information 203 which the universal scan software 202 or the OS has generated. This enables the scan function extension unit 206 to perform addition of a function which the extension application 204 provides. Moreover, the scan function extension unit 206 is able to perform, for example, addition of a function which the scanning device 102 supports but the universal scan software 202 does not support (the dropout color function) and addition of an exclusive relationship between setting values of the scan function. The OS launches the scan function extension unit 206 at the time when the extension application 204 has been associated with the scanning device 102 and the universal scan software 202 for the first time. Additionally, the OS can launch the scan function extension unit 206 at other timing such as the time of boot of the OS.

Moreover, the extension application 204 includes the notification unit 209. The notification unit 209 is able to display a notification to the user in response to the occurrence of an error in the scanning device 102. For example, when a scan jam error occurs in the scanning device 102, the universal scan software 202 detects the occurrence of such an error and the OS causes the display unit 119 to display a message with use of a notification function called “toast notification”, which is a function of the OS. In response to the toast notification being pressed by the user, the notification unit 209 of the extension application 204 is invoked by the OS, so that a user interface (UI) screen of the notification unit 209 is displayed. The UI screen of the notification unit 209 is able to be used to perform, for example, displaying of, for example, a detailed message of the scan jam error or a jam release method.

Moreover, the configuration of the extension application 204 for implementing the first embodiment is not limited to a configuration including all of the above-mentioned functions (units), but can be a configuration including only some of the functions or a configuration additionally including another function. Moreover, the extension application 204 may be simply called “scan software”. As described above, the extension application 204 can be said to include at least one of the following functions:
The first is the function of displaying a setting screen (the scan setting screen extension unit 205).
The second is the function of editing image data according to advanced settings (the image data editing unit 207).
The third is the function of extending a function which is able to be designated by image data generation software (the scan function extension unit 206).
The fourth is the function of displaying a screen in response to the occurrence of an error in the scanning device 102 (the notification unit 209).

### <Scan Setting Screen/Advanced Setting Screen>

Next, examples of the scan setting screen and the advanced setting screens in the first embodiment are described with reference to FIGS. 3A, 3B, and 3C.
FIG. 3A illustrates a scan setting screen which is displayed by the scan application 201.
FIG. 3B illustrates an advanced setting screen which is displayed in the case of a configuration in which the extension application 204 is not provided as illustrated in FIG. 2A.
FIG. 3C illustrates an advanced setting screen which is displayed in the case of a configuration in which the extension application 204 is provided as illustrated in FIG. 2B.

Furthermore, the unit or module which displays the scan setting screen is not limited to the above-mentioned one. For example, the scan setting screen extension unit 205 can be configured to only generate a display screen. In that case, the scan setting screen extension unit 205 can transmit the generated display screen to the scan application 201 via the universal scan software 202. The scan application 201 can be configured to display a display screen acquired via the universal scan software 202.

### <Scan Setting Screen (Scan Application)>

First, the scan setting screen which is displayed by the scan application 201, illustrated in FIG. 3A, is described.

A control 301 includes respective objects for allowing the user to set a scanner via which to scan image data (a scanner used for scanning (reading)).

A control 302 is an advanced setting button, and, in response to the control 302 being pressed, an additional scan screen is displayed by the universal scan software 202 or the scan setting screen extension unit 205.

A control 303 is a scan start button, and a control 304 is a button for cancelling scanning.

### <Advanced Setting Screen (Universal Scan Software)>

Next, an additional setting screen which is displayed by the universal scan software 202 in a case where the extension application 204 is not provided, illustrated in FIG. 3B, is described.

A control 305 is usable to set a scan destination, which, here, indicates that a platen glass is currently selected.

A control 306 is a setting end button, and, in response to the control 306 being pressed, the advanced setting screen returns to the scan setting screen illustrated in FIG. 3A.

### <Scan Setting Screen (Scan Setting Screen Extension Unit)>

Next, FIG. 3C is explained. FIG. 3C illustrates an additional setting screen which is displayed by the scan setting screen extension unit 205 in a case where the extension application 204 is provided. Unlike the setting screen illustrated in FIG. 3B, a control 307 and a list 308 are added. The control 307 is a button which is usable to select a setting item of the dropout color function, which, here, indicates that dropout color is currently selected. The list 308 indicates colors which are not read as a setting item of dropout color, in response to the control 307 being pressed. The list 308 indicates that, in addition to “red”, which is currently selected, there are “blue” and “green”. The user selects a setting serving as a desired dropout color condition from within the list 308 to switch the operation of the dropout color function and thus perform scanning.

Here, the reason why the additional setting screen illustrated in FIG. 3B and the additional setting screen illustrated in FIG. 3C differ in a scan setting item is described. The advanced setting screen is generated by referring to the scan capability generated based on the scan function information 203.

However, the universal scan software 202 is not compatible with the dropout color function and is, therefore, unable to add the dropout color function to the scan function information 203. Moreover, even if the dropout color function is originally included in the scan function information 203, the universal scan software 202 is unable to interpret the dropout color function included in the scan function information 203. Therefore, the universal scan software 202 is unable to display the dropout color setting in the advanced setting screen. However, the scan function extension unit 206 is configured to add the dropout color function to the scan function information 203 and the scan setting screen extension unit 205 is configured to display the advanced setting screen by referring to the scan capability. With these configurations employed, the extension application 204 becomes able to display the dropout color setting in the advanced setting screen.

Furthermore, the additional setting screen illustrated in FIG. 3C can additionally include an extension function other than the dropout color function.

### <Editing Processing of Scan Function Information: Scan Function Extension Unit>

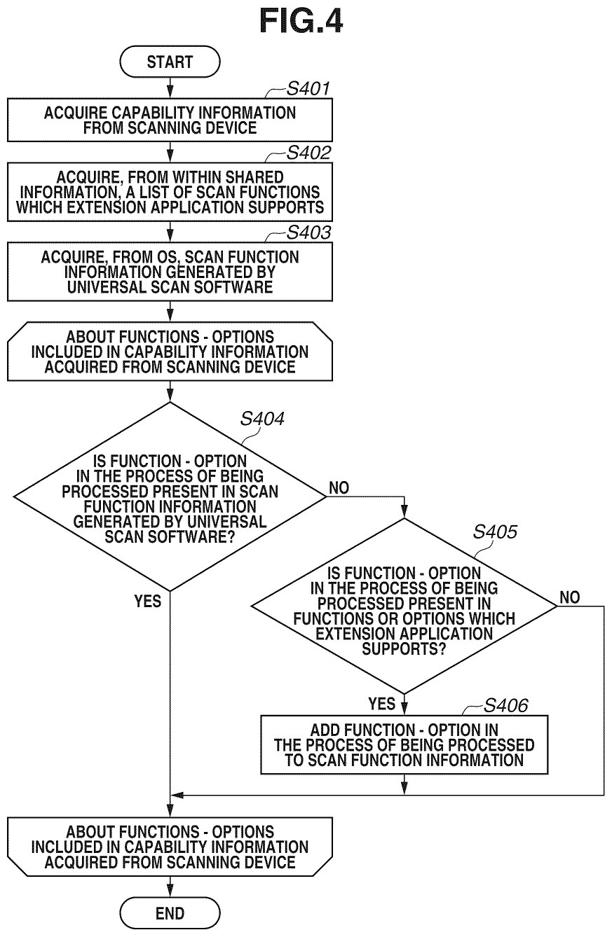

Here, a flowchart of processing which the scan function extension unit 206 performs to edit the scan function information 203 is described with reference to FIG. 4. Furthermore, steps in the flowchart of FIG. 4 are implemented by the CPU 111 reading out the respective units from the external storage device 114 onto the RAM 113 and executing the respective read-out units.

In step S401, the scan function extension unit 206 acquires capability information from the scanning device 102. The capability information includes attribute information indicating functions which are able to be designated in the scanning device 102 and setting values related to the attribute information.

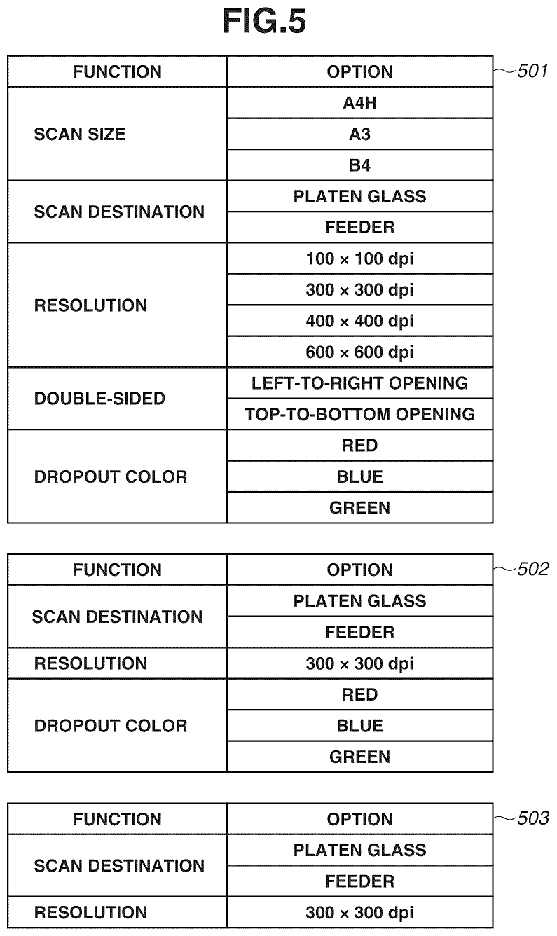

A table 501 illustrated in FIG. 5 shows an example of a list of pieces of capability information acquired from the scanning device 102. As shown in the table 501, it is possible to acquire, from the scanning device 102, functions such as scan size designation and options which are able to be set with respect to the respective functions.

In step S402, the scan function extension unit 206 acquires, from within the shared information 208, a list of scan functions which the extension application 204 supports. The list of scan functions which the extension application 204 supports is preliminarily stored in the shared information 208, and is a list in which all of the functions which the extension application 204 is able to process and setting values of the respective functions have been written. A table 502 illustrated in FIG. 5 shows an example of the list of scan functions which the extension application 204 supports. The list of scan functions which the extension application 204 supports may be updated by, for example, updating of the extension application 204.

In step S403, the scan function extension unit 206 acquires, from the OS, the scan function information 203 generated by the universal scan software 202. A table 503 illustrated in FIG. 5 shows an example of a list of scan functions which the universal scan software 202 supports. The scan function information 203 which the universal scan software 202 generates is generated based on the capability information (the table 501 illustrated in FIG. 5) which the universal scan software 202 has acquired from the scanning device 102. Since only the scan functions which the universal scan software 202 supports out of the capability information acquired from the scanning device 102 are written in the scan function information 203 which the universal scan software 202 generates, the functions written in the scan function information are limitative. For example, the dropout color function is included in the capability information acquired from the scanning device 102 (the table 501 illustrated in FIG. 5). However, the universal scan software 202 does not support the dropout color function and the dropout color function is not written in the scan function information. The scan function extension unit 206 adding a function-option to the scan function information enables the extension application 204 to compensate for the lack of functions of the universal scan software 202. Moreover, the scan function extension unit 206 is able to remove an unnecessary function—option from the scan function information which is generated by the universal scan software 202.

In subsequent steps S404, S405, and S406, processing is repeatedly performed with respect to the list of functions included in the capability information acquired from the scanning device 102 in step S401. In the first embodiment, the processing is repeatedly performed with respect to 14 types of options including “scan size: A4H” to “dropout color: green” included in the table 501.

In step S404, the scan function extension unit 206 determines whether the function—option in the process of being processed is present in the scan function information 203 generated by the universal scan software 202. If it is determined that the function—option in the process of being processed is present in the scan function information 203 (YES in step S404), the scan function extension unit 206 returns the processing to the beginning of the loop processing. Specifically, the scan function extension unit 206 selects a next item from among the functions or options included in the capability information acquired from the scanning device 102 and then performs step S404 again. If the scan function extension unit 206 is in the process of processing the last item from among the functions or options included in the capability information acquired from the scanning device 102, the scan function extension unit 206 exits the loop processing and then ends the processing in the flowchart of FIG. 4. If it is determined that the function—option in the process of being processed is not present in the scan function information 203 (NO in step S404), the scan function extension unit 206 advances the processing to step S405. In the first embodiment, since, for example, “scan destination: platen glass” shown in the table 501 indicating the scan functions of the scanning device 102 is also present in the table 503 indicating the scan functions of the universal scan software 202, the result of determination in step S404 is YES. On the other hand, since “dropout color” shown in the table 501 is not present in the table 503, the result of determination in step S404 is NO, so that the scan function extension unit 206 advances the processing to step S405.

In step S405, the scan function extension unit 206 determines whether the function—option in the process of being processed is present in the functions or options which the extension application 204 supports. If it is determined that the function—option in the process of being processed is present (YES in step S405), the scan function extension unit 206 (CPU 111) advances the processing to step S406. If it is determined that the function—option in the process of being processed is not present (NO in step S405), as with the case where the result of determination in step S404 is YES, the scan function extension unit 206 (CPU 111) returns the processing to step S404 or ends the processing in the flowchart of FIG. 4. In the first embodiment, for example, in a case where the function—option in the process of being processed is “dropout color”, since the function—option in the process of being processed is also present in the table 502 indicating the capability information about the extension application 204, the result of determination in step S405 is YES, so that the scan function extension unit 206 (CPU 111) advances the processing to step S406.

Next, in step S406, the scan function extension unit 206 adds the function—option in the process of being processed to the scan function information 203. After the processing operation in step S406, as with the case where the result of determination in step S404 is YES, the scan function extension unit 206 performs step S404 again or ends the processing in the flowchart of FIG. 4.

As described above, the scan function extension unit 206 adds, to the scan function information 203, a function—option with which the universal scan software 202 is incompatible, the scanning device 102 is compatible, and the extension application 204 is compatible. Thus, a scan capability is generated based on the scan function information 203 edited by such processing. Additionally, the scan setting screen extension unit 205 generating a display screen based on the generated scan capability enables extending a function with which the universal scan software 202 is incompatible and thus displaying the advanced setting screen illustrated in FIG. 3C.

### <Sequence of Scan Processing>

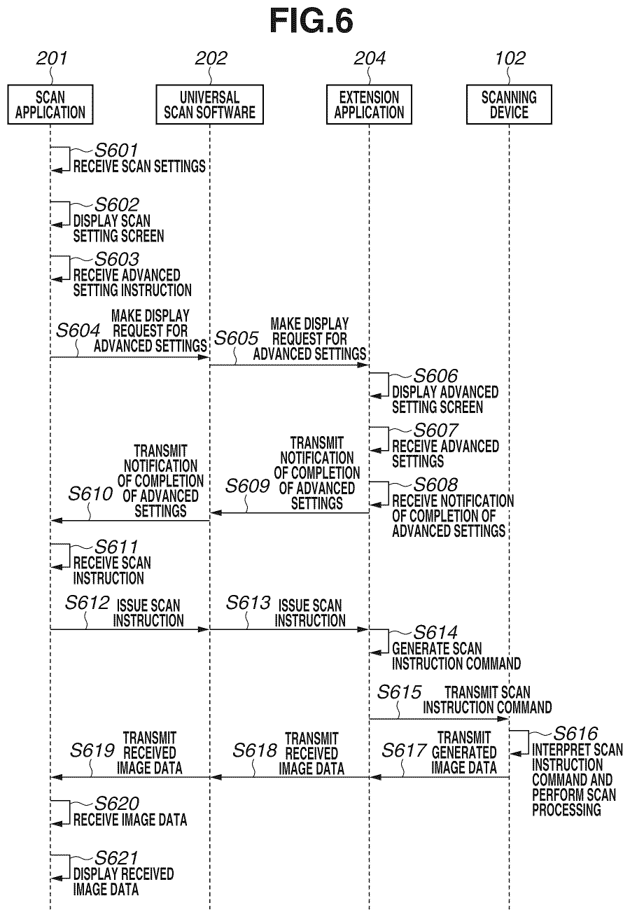

Next, a sequence of operations of the scan application 201, the universal scan software 202, the extension application 204, and the scanning device 102 after the scan application 201 receives scan settings is described with reference to FIG. 6. Furthermore, steps other than a step which is performed by the scanning device 102, illustrated in FIG. 6, are implemented by the CPU 111 reading out the scan application 201, the universal scan software 202, and the extension application 204 from the external storage device 114 onto the RAM 113 and executing them. The step which is performed by the scanning device 102 illustrated in FIG. 6 is implemented by the CPU 191 of the scanning device 102 reading out a program stored in the ROM 192 or the external storage device 199 onto the RAM 193 and executing the program.

In step S601, the scan application 201 receives scan settings performed by the user.

The user can operate the pointing device 117 or the keyboard 118 to issue an instruction for scan settings to the scan application 201.

In step S602, the scan application 201 displays the scan setting screen illustrated in FIG. 3A on the display unit 119.

In step S603, the scan application 201 receives an advanced setting instruction. The user can operate the pointing device 117 or the keyboard 118 to select the control 302, thus issuing an instruction for advanced settings.

In step S604, the scan application 201 makes a display request for advanced settings to the universal scan software 202.

In step S605, the universal scan software 202 makes a display request for advanced settings to the extension application 204. Furthermore, as mentioned above, in the case of the configuration illustrated in FIG. 2A, the universal scan software 202 comes to display the advanced setting screen illustrated in FIG. 3C.

In step S606, the scan setting screen extension unit 205 of the extension application 204 causes the display unit 119 to display the advanced setting screen illustrated in FIG. 3C. This is because, as described above with reference to FIG. 4, the dropout color setting has been added to the scan function information 203 by the scan function extension unit 206. The scan setting screen extension unit 205 causes the display unit 119 to display the advanced setting screen illustrated in FIG. 3C by reference to the scan capability generated based on the scan function information subjected to addition.

In step S607, the scan setting screen extension unit 205 receives advanced settings. In the first embodiment, it is assumed that, as illustrated in FIG. 3C, “scan destination: platen glass” and “dropout color” have been selected by the user. The received settings are then stored in the RAM 113 by the CPU 111.

In step S608, the scan setting screen extension unit 205 receives a notification indicating completion of advanced settings and issues an instruction for writing the received settings into the scan setting information. The user can operate the pointing device 117 or the keyboard 118 to select the control 306, thus issuing an instruction for completing advanced settings.

In step S609, the extension application 204 transmits a notification indicating completion of advanced settings to the universal scan software 202.

In step S610, the universal scan software 202 transmits a notification indicating completion of advanced settings to the scan application 201.

Next, in step S611, the scan application 201 receives a scan instruction from the user. The user can operate the pointing device 117 or the keyboard 118 to select the control 303, thus issuing an instruction for scanning.

In step S612, the scan application 201 issues a scan instruction to the universal scan software 202.

In step S613, the universal scan software 202 issues a scan instruction to the extension application 204.

In step S614, the extension application 204 generates a scan instruction command based on the scan setting information subjected to writing in step S608.

In step S615, the extension application 204 transmits the scan instruction command to the scanning device 102, thus issuing a scan instruction.

In step S616, the scanning device 102 interprets the scan instruction command and thus performs scanning.

At the time of performing scanning, the scanning device 102 performs necessary image processing on image data corresponding to the scan instruction.

In the first embodiment, in a case where the scan settings illustrated in FIG. 3C have been performed, image data from which red color included in an original has been removed is generated.

In step S617, the scanning device 102 transmits the generated image data to the extension application 204.

In step S618, the extension application 204 transmits the received image data to the universal scan software 202.

In step S619, the universal scan software 202 transmits the received image data to the scan application 201.

In step S620, the scan application 201 receives the image data.

In step S621, the scan application 201 performs displaying of the received image data, and then ends the present processing.

### <Scan Processing: Extension Application>

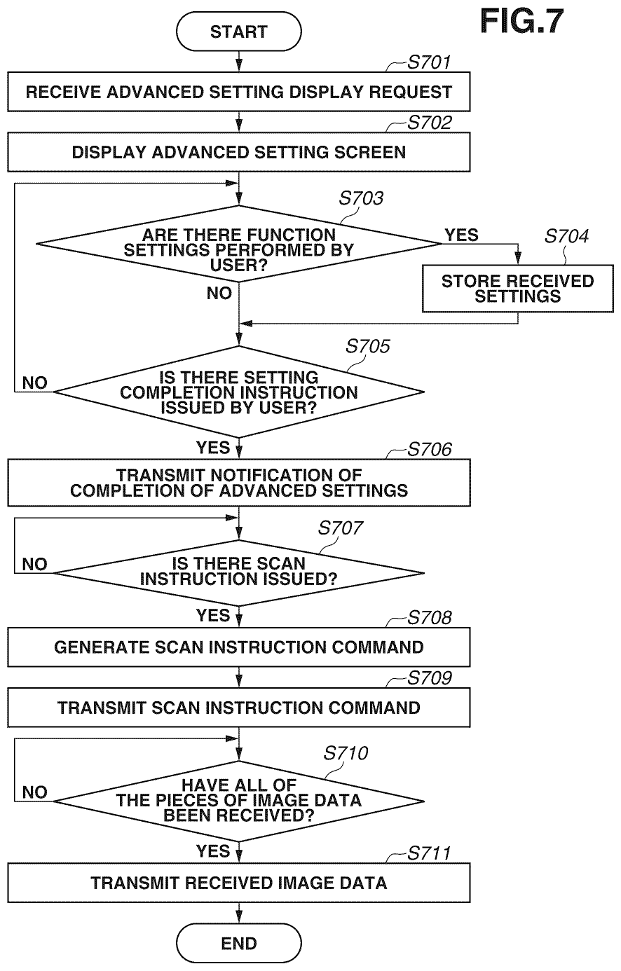

Here, a flowchart of processing which the extension application 204 performs to perform scan processing is described with reference to FIG. 7. Furthermore, steps in the flowchart of FIG. 7 are implemented by the CPU 111 reading out the respective units from the external storage device 114 onto the RAM 113 and executing the respective read-out units.

In step S701, the extension application 204 receives an advanced setting display request.

In step S702, the scan setting screen extension unit 205 of the extension application 204 causes the display unit 119 to display the advanced setting screen illustrated in FIG. 3C. This is because, as described with reference to FIG. 4, the dropout color setting is added to the scan function information 203 by the scan function extension unit 206. By referring to the scan capability generated based on the scan function information subjected to addition, the scan setting screen extension unit 205 causes the display unit 119 to display the advanced setting screen illustrated in FIG. 3C.

In step S703, the scan setting screen extension unit 205 determines whether there are function settings performed by the user. If it is determined that there are function settings performed by the user (YES in step S703), the CPU 111 advances the processing to step S704, and, if it is determined that there are no function settings performed by the user (NO in step S703), the CPU 111 advances the processing to step S705.

In step S704, the CPU 111 receives advanced settings, stores the received settings in the RAM 113, and then advances the processing to step S705.

In step S705, the scan setting screen extension unit 205 determines whether there is a setting completion instruction issued by the user. If it is determined that there is a setting completion instruction (YES in step S705), the CPU 111 receives a notification of completion of advanced settings, writes the received settings into the scan setting information, and then advances the processing to step S706. If it is determined that there is no setting completion instruction (NO in step S705), the CPU 111 returns the processing to step S703, in which the scan setting screen extension unit 205 determines again whether there are function settings performed by the user.

In step S706, the extension application 204 transmits a notification of completion of the advanced settings to the universal scan software 202.

In step S707, the extension application 204 determines whether there is a scan instruction issued from the universal scan software 202. If it is determined that there is a scan instruction (YES in step S707), the CPU 111 advances the processing to step S708, and, if it is determined that there is no scan instruction (NO in step S707), the CPU 111 returns the processing to step S707, in which the extension application 204 determines again whether there is a scan instruction issued from the universal scan software 202.

In step S708, the extension application 204 generates a scan instruction command based on the scan setting information subjected to writing in step S705.

The method of generating a scan instruction command in step S708 includes, first, a method of extending a command defined in the standard protocol. The method of extension includes, for example, a method of writing a dedicated command into the extension region of the command defined in the standard protocol. Additionally, the method of extension includes, for example, a method of adding an original standard command to the tail end of the command defined in the standard protocol and a method in which the extension application 204 overwrites the command defined in the standard protocol with an original command system.

Next, in step S709, the extension application 204 transmits the scan instruction command to the scanning device 102, thus issuing a scan instruction.

Moreover, a configuration in which, when issuing an instruction, the extension application 204 performs an instruction and communication with a vendor-specific protocol irrespective of the standard protocol can be employed.

In step S710, the extension application 204 determines whether all of the pieces of image data have been received from the scanning device 102. If it is determined that all of the pieces of image data have been received (YES in step S710), the CPU 111 advances the processing to step S711, and, if not so (NO in step S710), the CPU 111 returns the processing to step S710, in which the extension application 204 determines whether all of the pieces of image data have been received from the scanning device 102.

In step S711, the extension application 204 transmits the received image data to the universal scan software 202, and then ends the present processing.

### <Scan Processing: Scanning Device>

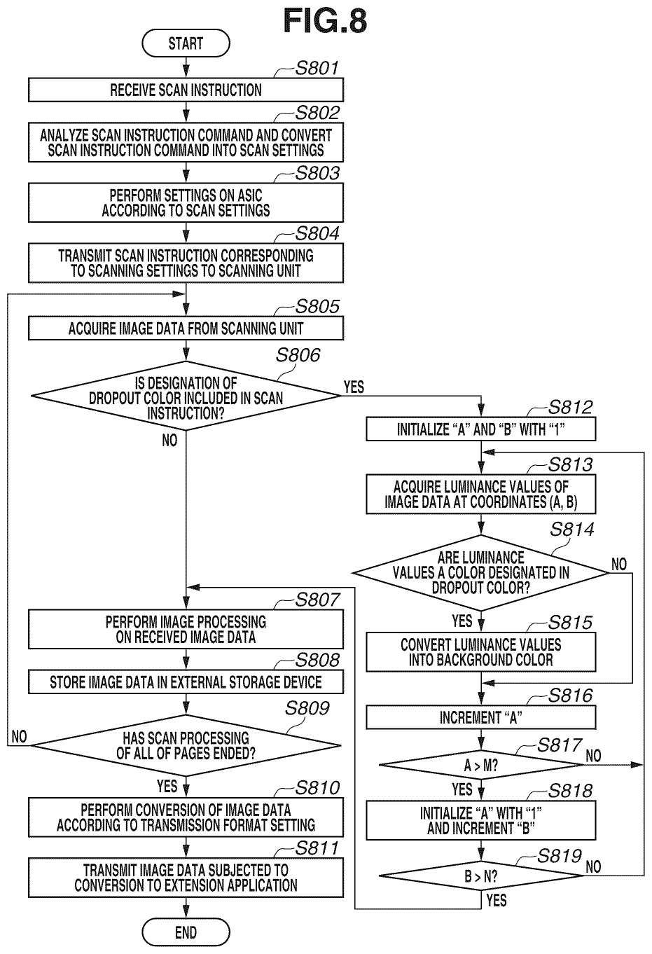

Next, a flowchart of scan processing which the scanning device 102 performs upon receiving a scan instruction from the extension application 204 is described with reference to FIG. 8. Furthermore, operations (steps) illustrated in the flowchart of FIG. 8 are implemented by the CPU 191 executing a program stored in the ROM 192.

In step S801, the CPU 191 receives the scan instruction transmitted from the extension application 204.

In step S802, the CPU 191 analyzes the scan instruction command received in step S801, and converts the scan instruction command into scan settings with which the scanning device 102 is able to perform scan processing. In the first embodiment, the CPU 191 performs scan settings with, at the platen glass, resolution: 300×300 dots per inch (dpi) and dropout color.

In step S803, the CPU 191 determines an application specific integrated circuit (ASIC) of the image processing unit 190 which is to be used for performing scanning, according to the scan settings obtained by conversion in step S802, and performs settings on the determined ASIC.

In step S804, the CPU 191 transmits a scan instruction corresponding to the scanning settings to the scanning unit 195. In the first embodiment, the CPU 191 transmits an instruction in such a way as to perform dropout color scanning at the platen glass.

In step S805, the CPU 191 acquires image data from the scanning unit 195.

In step S806, the CPU 191 determines whether the designation of dropout color is included in the scan instruction. If it is determined that the designation of dropout color is included in the scan instruction (YES in step S806), the CPU 191 advances the processing to step S812, and, if not so (NO in step S806), the CPU 191 advances the processing to step S807.

In step S812, the CPU 191 sets the coordinates of image data of interest as (A, B) and initializes, with “1”, each of variables A and B, which are internally used to compare a printing image and a read image with each other. Moreover, in the first embodiment, the CPU 191 assumes that the number of pixels of the width of image data is M and the number of pixels of the height of image data is N. In the first embodiment, the CPU 191 handles pixels using coordinates, but can perform conversion into vectors.

In step S813, the CPU 191 acquires luminance values of image data at the coordinates (A, B).

In step S814, the CPU 191 determines whether the luminance values acquired in step S813 are a color designated in dropout color. If it is determined that the acquired luminance values are a color designated in dropout color (YES in step S814), the CPU 191 advances the processing to step S815, and, if not so (NO in step S814), the CPU 191 advances the processing to step S816.

In step S815, the CPU 191 converts the luminance values at the coordinates (A, B) of image data into a background color.

In step S816, to proceed with the processing for a next pixel, the CPU 191 increments the variable A by one.

In step S817, the CPU 191 determines whether A>M (the variable A is greater than the number M). If it is determined that A>M (YES in step S817), the CPU 191 advances the processing to step S818, and, if not so (NO in step S817), the CPU 191 returns the processing to step S813.

In step S818, to process pixels in a next row, the CPU 191 assigns “1” to the variable A and increments the variable B by one.

In step S819, the CPU 191 determines whether B>N (the variable B is greater than the number N). If it is determined that B>N (YES in step S819), the CPU 191 determines that the CPU 191 has processed all of the pixels of image data and advances the processing to step S807, and, if not so (NO in step S819), the CPU 191 returns the processing to step S813.

In step S807, the CPU 191 and the image processing unit 190 perform image processing on the received image data. In the first embodiment, the CPU 191 and the image processing unit 190 perform conversion into resolution: 300×300 dpi. A configuration in which, if the scanning unit 195 is capable of performing scanning with 300×300 dpi, the scanning unit 195 acquires image data with 300×300 dpi and the CPU 191 and the image processing unit 190 do not perform image processing in step S807 can be employed.

In step S808, the CPU 191 stores the image data in the external storage device 199.

In step S809, the CPU 191 determines whether scan processing of all of the pages has ended. If it is determined that scan processing of all of the pages has not yet ended (NO in step S809), the CPU 191 returns the processing to step S805, in which the CPU 191 performs scan processing of the next page. If it is determined that scan processing of all of the pages has ended (YES in step S809), the CPU 191 advances the processing to step S810.

In step S810, the CPU 191 and the image processing unit 190 perform conversion of the image data previously stored in step S807 according to the transmission format setting previously received in step S801. In the first embodiment, the transmission format is not included in the scan instruction received from the extension application 204. Therefore, while it is assumed that the CPU 191 and the image processing unit 190 perform conversion according to Joint Photographic Experts Group (JPEG), which is a default in the scanning device 102, the transmission format to be used for conversion is not limited to this, but can be any one of formats capable of being handled by an information processing apparatus.

In step S811, the CPU 191 transmits the image data subjected to conversion to the extension application 204, and then ends the present processing.

As described above, in the first embodiment, the scan setting screen extension unit 205 of the extension application 204 modifies the scan function information 203 based on respective pieces of capability information about the universal scan software 202, the extension application 204, and the scanning device 102. Additionally, when requested to display the advanced setting screen from the user, the scan setting screen extension unit 205 performs displaying of the setting screen based on the scan capability generated from the scan function information 203, thus allowing the user to perform dropout color setting.

After that, upon receiving a scan instruction having dropout color setting reflected therein, the scanning device 102 performs scanning of an original in such way as to remove the designated color. The above-described series of processing operations enables the scanning device 102 to implement the dropout color function, thus enabling providing the dropout color function to the user.

Furthermore, while the first embodiment has been described with use of the advanced setting screen illustrated in FIG. 3C under the configuration illustrated in FIG. 2B, the first embodiment is not limited to this. For example, in a case where an advanced setting display request has been made to the universal scan software 202 in step S604, the universal scan software 202 can display an advanced setting screen illustrated in FIG. 3B. Next, after displaying of the advanced setting screen illustrated in FIG. 3B, the universal scan software 202 can request the extension application 204 to display an additional advanced setting screen. Next, the universal scan software 202 can request the extension application 204 to additionally display an advanced setting screen available for dropout color setting.

Moreover, while a configuration in which a scan instruction to the extension application 204 is issued from the universal scan software 202 is employed, the first embodiment is not limited to this configuration. For example, a method in which the scan instruction is issued from the scan application 201 to the extension application 204 or a configuration in which a control for the scan instruction is arranged in the advanced setting screen and the user directly issues the scan instruction to the extension application 204 can be employed. Moreover, the method of passing image data can be a method of directly passing image data from the extension application 204 to the scan application 201 without via the universal scan software 202 or a method of passing image data from the scanning device 102 to the scan application 201. Moreover, the method of passing image data can be a method of storing received image data in the external storage device 114 and passing only information about a file path serving as a storage location.

Additionally, when requested to display the advanced setting screen from the user, the scan setting screen extension unit 205 performs displaying of the setting screen based on the scan capability generated from the scan function information 203, thus allowing the user to perform dropout color setting. After that, upon receiving a scan instruction having dropout color setting reflected therein, the scanning device 102 performs scanning of an original with the designated dropout color setting. The above-described series of processing operations enables the scanning device 102 to implement the dropout color function, thus enabling providing the dropout color function to the user.

Furthermore, while the first embodiment has been described with use of the advanced setting screen illustrated in FIG. 3C under the configuration illustrated in FIG. 2B, the first embodiment is not limited to this. For example, in a case where an advanced setting display request has been made to the universal scan software 202 in step S604, the universal scan software 202 can display an advanced setting screen illustrated in FIG. 3B. Next, after displaying of the advanced setting screen illustrated in FIG. 3B, the universal scan software 202 can request the extension application 204 to display an additional advanced setting screen. Next, the universal scan software 202 can request the extension application 204 to additionally display an advanced setting screen available for dropout color setting.

Moreover, while a configuration in which a scan instruction to the extension application 204 is issued from the universal scan software 202 is employed, the first embodiment is not limited to this configuration. For example, a method in which the scan instruction is issued from the scan application 201 to the extension application 204 or a configuration in which a control for the scan instruction is arranged in the advanced setting screen and the user directly issues the scan instruction to the extension application 204 can be employed. Moreover, the method of passing image data can be a method of directly passing image data from the extension application 204 to the scan application 201 without via the universal scan software 202 or a method of passing image data from the scanning device 102 to the scan application 201. Moreover, the method of passing image data can be a method of storing received image data in the external storage device 114 and passing only information about a file path serving as a storage location.

Moreover, while, in the first embodiment, a method in which, in a case where there is a plurality of pieces of image data, passing of image data is performed after all of the pieces of image data have been received is employed, a method in which respective pieces of image data are passed as needed can also be employed.

Moreover, a configuration in which, when issuing an instruction, the extension application 204 performs communication with a vendor-specific protocol irrespective of the standard protocol can also be employed.

### Second Embodiment

Next, a second embodiment of the present disclosure is described. In the above-described first embodiment, first, the scanning device 102 interprets scan setting information including dropout color, and the scanning device 102 performs scan processing in such a way as to remove a color designated by the side of the scanning device 102.

However, some scanning devices may originally not support the dropout color function. In such a case, the user is unable to use the dropout color function.

Therefore, in the second embodiment, first, an information processing apparatus determines whether a scanning device supports the dropout color function. Next, if the scanning device supports the dropout color function, the information processing apparatus generates scan setting information including the dropout color function designated by the user, and passes the generated scan setting information to the scanning device. On the other hand, if the scanning device does not support the dropout color function, the information processing apparatus generates scan setting information without the inclusion of dropout color setting, and passes the generated scan setting information to the scanning device. After that, the information processing apparatus removes the designated color from image data obtained by scanning performed by the scanning device. This enables, even in a case where it is impossible to perform dropout color in the scanning device, providing image data from which a color designated by the user has been removed.

Furthermore, in the following description, only differences from those in the first embodiment are described.

It is assumed that the scanning device 102 does not support the dropout color function. The extension application 204 in the second embodiment differs in configuration from the extension application 204 in the first embodiment. Even in a case where the dropout color function is not included in the capability information acquired from the scanning device 102, if a unit capable of removing a designated color is included in the extension application 204, the scan function extension unit 206 adds the dropout color function to the scan function information 203. The image data editing unit 207 performs dropout color processing on image data received from the scanning device 102, based on the color set by the user. The details thereof are described below.

### <Editing Processing of Scan Function Information: Scan Function Extension Unit>

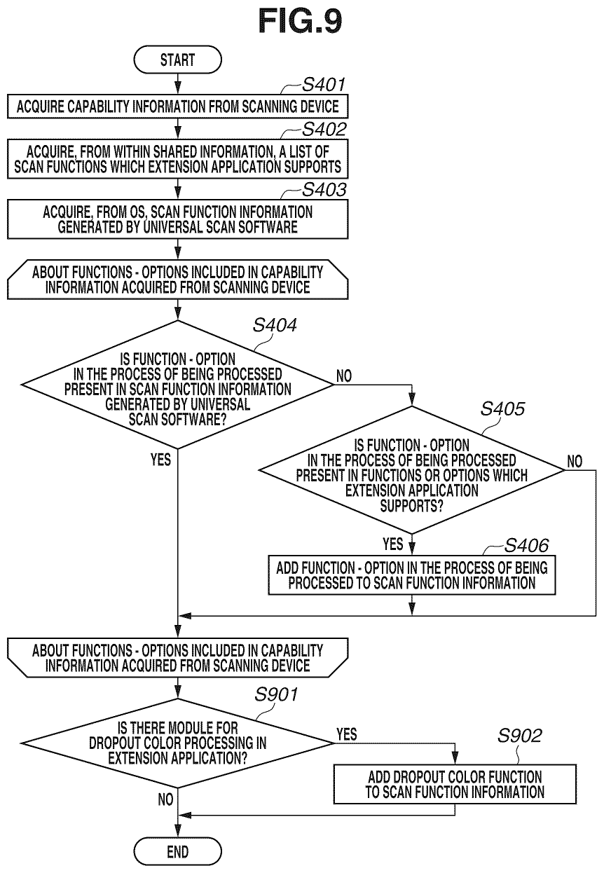

Editing processing of scan function information which the scan function extension unit 206 in the second embodiment performs is described with reference to FIG. 9. Furthermore, steps in the flowchart of FIG. 9 are implemented by the CPU 111 reading out the respective units from the external storage device 114 onto the RAM 113 and executing the respective read-out units.

After repetitive processing operations in steps S404 to S406 have ended, the scan function extension unit 206 advances the processing to step S901. Here, the scanning device 102 does not support the dropout color function. Therefore, the dropout color function is still not added to the scan function information 203 subjected to the processing operations in steps S404 to S406.

Thus, in steps S901 and S902, the scan function extension unit 206 performs processing for adding a function to the scan function information 203 according to a module which is not included in the capability information received from the scanning device 102 but is included in the extension application 204.

Specifically, in step S901, the scan function extension unit 206 refers to the table 501 illustrated in FIG. 5 and the scan function information 203 and determines whether there is a module for performing dropout color processing in the extension application 204. If it is determined that there is a module for performing dropout color processing (YES in step S901), the scan function extension unit 206 advances the processing to step S902, and, if it is determined that there is no module for performing dropout color processing (NO in step S901), the scan function extension unit 206 ends the present processing. In the second embodiment, since the image data editing unit 207 of the extension application 204 is able to perform dropout color processing, it is determined that there is a module for performing dropout color processing in the extension application 204.

Next, in step S902, the scan function extension unit 206 adds the dropout color function to the scan function information 203, and then ends the present processing.

As described above, first, the scan function extension unit 206 adds, to the scan function information 203, a function-option with which the universal scan software 202 is incompatible, the scanning device 102 is compatible, and the extension application 204 is compatible. After that, the scan function extension unit 206 determines whether the extension application 204 is able to perform dropout color processing, and, if it is determined that the extension application 204 is able to perform dropout color processing, the scan function extension unit 206 adds the dropout color function to the scan function information 203. With this processing, even in a case where the scanning device 102 is not able to perform dropout color processing, the scan setting screen extension unit 205 generating a display screen based on the scan function information 203 enables displaying the advanced setting screen illustrated in FIG. 3C.

### <Sequence of Scan Processing>

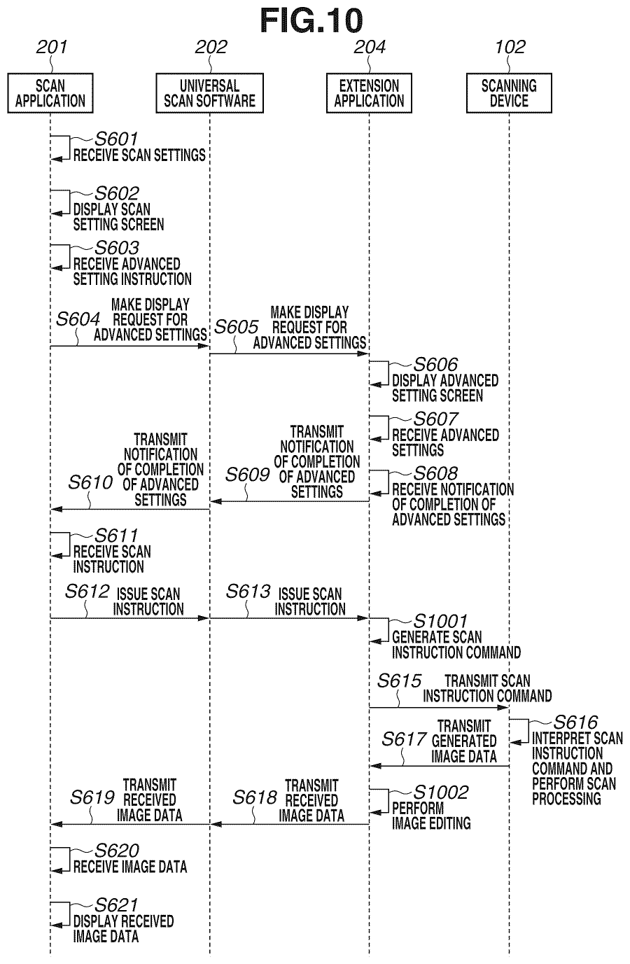

Next, a sequence of operations of the scan application 201, the universal scan software 202, the extension application 204, and the scanning device 102 after the scan application 201 receives scan settings is described with reference to FIG. 10. Furthermore, steps other than a step which is performed by the scanning device 102, illustrated in FIG. 10, are implemented by the CPU 111 reading out the scan application 201, the universal scan software 202, and the extension application 204 from the external storage device 114 onto the RAM 113 and executing them. The step which is performed by the scanning device 102 illustrated in FIG. 10 is implemented by the CPU 191 of the scanning device 102 reading out a program stored in the ROM 192 or the external storage device 199 onto the RAM 193 and executing the program. In the following description, steps in common with those illustrated in FIG. 6 are assigned the respective same step numbers as those illustrated in FIG. 6 and are omitted from description here, and differences therebetween are mainly described.

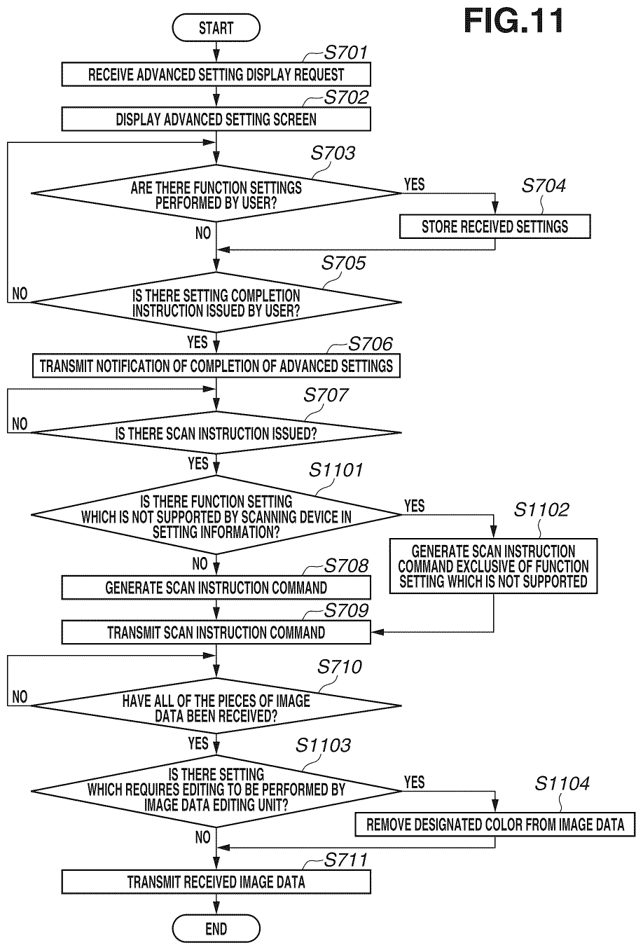

In step S1001, the extension application 204 generates a scan instruction command. The detailed operation thereof performed at this time is described below with reference to the flowchart of FIG. 11.

In step S1002, the image data editing unit 207 performs image editing on the received image data. In the second embodiment, the image data editing unit 207 performs dropout color processing to remove the designated color from image data.

### <Scan Processing: Extension Application>

Here, a flowchart of processing which the extension application 204 performs to perform scan processing are described with reference to FIG. 11. steps in common with those illustrated in FIG. 7 are assigned the respective same step numbers as those illustrated in FIG. 7 and are omitted from description here, and differences therebetween are mainly described. Furthermore, steps in the flowchart of FIG. 11 are implemented by the CPU 111 reading out the respective units from the external storage device 114 onto the RAM 113 and executing the respective read-out units.

In step S1101, the extension application 204 acquires capability information about the scanning device 102 from the shared information 208. Furthermore, if there is no capability information about the scanning device 102, the scan function extension unit 206 can request capability information from the scanning device 102 and then store the received capability information in the shared information 208.

Then, the extension application 204 determines whether there is a function setting which is not supported by the scanning device 102 (whether the dropout color function is included in the scanning device 102), based on the acquired capability information and the setting information. If it is determined that a function which is not supported by the scanning device 102 is currently set (YES in step S1101), the CPU 111 advances the processing to step S1102. In the second embodiment, since the dropout color, which is not supported by the scanning device 102, is currently set, the CPU 111 advances the processing to step S1102. If it is determined that a function which is not supported by the scanning device 102 is not currently set (NO in step S1101), the CPU 111 advances the processing to step S708.

Next, in step S1102, the extension application 204 generates a scan instruction command exclusive of the function setting which is not supported. In the second embodiment, as a result, the dropout color function is not included in the scan instruction command. Then, the extension application 204 advances the processing to step S709.

Next, a subsequent processing operation which is performed in a case where, in step S710, it is determined that all of the pieces of image data have been received (YES in step S710) is described.

In step S1103, the extension application 204 determines whether there is a setting which requires editing to be performed by the image data editing unit 207, based on the setting information. If it is determined that there is a setting which requires editing (YES in step S1103), the CPU 111 advances the processing to step S1104. In the second embodiment, since the dropout color function, which the scanning device 102 is not able to effect, is currently set, the CPU 111 advances the processing to step S1104. On the other hand, if it is determined that there is no setting which requires editing (NO in step S1103), the CPU 111 advances the processing to step S711.

In step S1104, the image data editing unit 207 performs dropout color processing to remove the designated color from image data.

As described above, in the second embodiment, even in a case where the scanning device does not support the dropout color function, it becomes possible to provide the dropout color function to the user.

### Third Embodiment

Next, a third embodiment of the present disclosure is described. In the above-described first and second embodiments, a configuration in which the extension application 204 and the scanning device 102 communicate with each other has been described.

In the third embodiment, a configuration in which a unit which communicates with the scanning device 102 is only the universal scan software 202 and the extension application 204 performs only extension of a scan command or image editing is described.

Furthermore, in the following description, only differences from those in the first and second embodiments are described.

### <Sequence of Scan Processing (Extension of Command)>

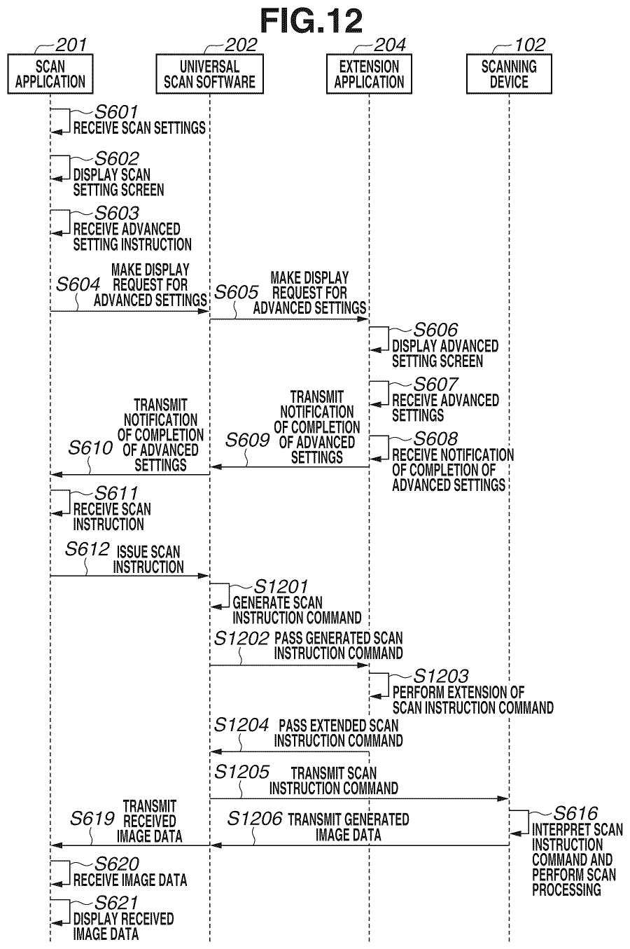

A sequence of operations of the scan application 201, the universal scan software 202, the extension application 204, and the scanning device 102 after the scan application 201 receives scan settings is described with reference to FIG. 12. Steps in common with those illustrated in FIG. 6 are assigned the respective same step numbers as those illustrated in FIG. 6 and are omitted from description here, and differences therebetween are mainly described. Furthermore, steps other than a step which is performed by the scanning device 102, illustrated in FIG. 12, are implemented by the CPU 111 reading out the scan application 201, the universal scan software 202, and the extension application 204 from the external storage device 114 onto the RAM 113 and executing them. The step which is performed by the scanning device 102 illustrated in FIG. 12 is implemented by the CPU 191 of the scanning device 102 reading out a program stored in the ROM 192 or the external storage device 199 onto the RAM 193 and executing the program.

In step S1201, the universal scan software 202 generates a scan instruction command. In this instance, a function which is not supported by the universal scan software 202 is not written into the scan instruction command.

In step S1202, the universal scan software 202 passes the generated scan instruction command to the extension application 204.

In step S1203, the extension application 204 performs additional writing of an instruction command for the function which is not supported by the universal scan software 202 into the received scan instruction command or changing of existing instructions, thus performing extension of the command. In the third embodiment, since the dropout color setting is not included in the scan instruction command generated by the universal scan software 202 in step S1201, the extension application 204 adds the dropout color setting.

In step S1204, the extension application 204 passes the extended scan instruction command to the universal scan software 202.

In step S1205, the universal scan software 202 transmits the scan instruction command to the scanning device 102, thus issuing a scan instruction.

In step S1206, the universal scan software 202 receives image data from the scanning device 102.

### <Sequence of Scan Processing (Image Editing)>

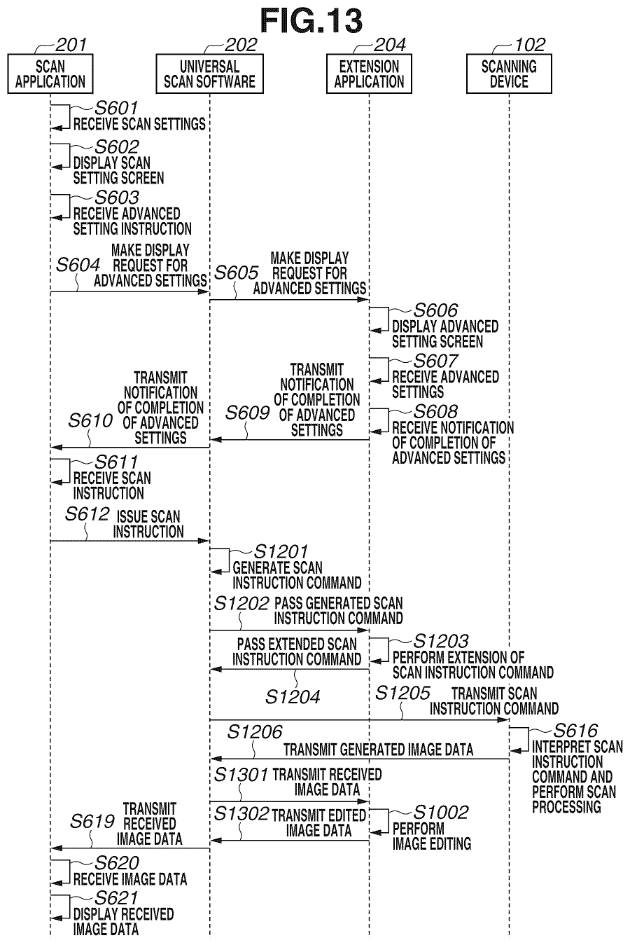

Next, a sequence of operations in which the extension application 204 performs image editing in a case where the universal scan software 202 and the scanning device 102 communicate with each other is described with reference to FIG. 13. Steps in common with those illustrated in FIG. 12 are assigned the respective same step numbers as those illustrated in FIG. 12 and are omitted from description here, and differences therebetween are mainly described. Furthermore, steps other than a step which is performed by the scanning device 102, illustrated in FIG. 13, are implemented by the CPU 111 reading out the scan application 201, the universal scan software 202, and the extension application 204 from the external storage device 114 onto the RAM 113 and executing them. The step which is performed by the scanning device 102 illustrated in FIG. 13 is implemented by the CPU 191 of the scanning device 102 reading out a program stored in the ROM 192 or the external storage device 199 onto the RAM 193 and executing the program.

In step S1301, the universal scan software 202 transmits the received image data to the extension application 204.

In step S1002, the extension application 204 performs image editing. In the third embodiment, the extension application 204 performs a processing operation similar to that in step S1104 illustrated in FIG. 11 to remove the designated color from image data.

In step S1302, the extension application 204 transmits the edited image data to the universal scan software 202.

As described above, in the third embodiment, the extension application 204 extending the dropout color designation command enables the scanning device 102 to implement the dropout color function.

### Fourth Embodiment

Next, a fourth embodiment of the present disclosure is described. In the above-described first to third embodiments, a configuration in which a command to be used in the standard protocol is extended and the extended command is communicated to the scanning device 102 has been described.

In the fourth embodiment, a configuration in which a command to be used in the standard protocol is not extended and a different command is communicated to the scanning device 102 with respect to a function which is supported by only the extension application 204 is described.

Furthermore, in the following description, only differences from those in the above-described embodiments are described.

### <Sequence of Scan Processing (Different Command Transmission)>

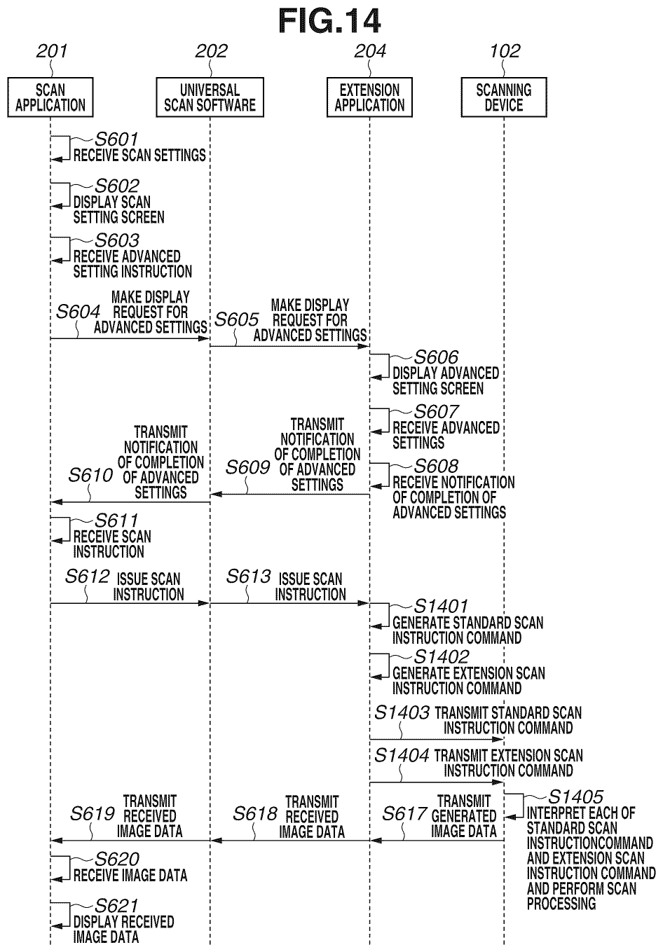

A sequence of operations of the scan application 201, the universal scan software 202, the extension application 204, and the scanning device 102 after the scan application 201 receives scan settings is described with reference to FIG. 14. Furthermore, steps other than a step which is performed by the scanning device 102, illustrated in FIG. 14, are implemented by the CPU 111 reading out the scan application 201, the universal scan software 202, and the extension application 204 from the external storage device 114 onto the RAM 113 and executing them. The step which is performed by the scanning device 102 illustrated in FIG. 14 is implemented by the CPU 191 of the scanning device 102 reading out a program stored in the ROM 192 or the external storage device 199 onto the RAM 193 and executing the program. Steps in common with those illustrated in FIG. 6 are assigned the respective same step numbers as those illustrated in FIG. 6 and are omitted from description here, and differences therebetween are mainly described.

In step S1401, the extension application 204 generates a standard scan instruction command compliant with the standard protocol. In this instance, a function which is not supported by the standard protocol is not written into the scan instruction command.

In step S1402, the extension application 204 generates an extension scan instruction command for a function which is supported by only the extension application 204.

In step S1403, the extension application 204 transmits the standard scan instruction command to the scanning device 102, thus issuing a scan instruction.

In step S1404, the extension application 204 transmits the extension scan instruction command to the scanning device 102, thus issuing a scan instruction.

In step S1405, the scanning device 102 interprets each of the received standard scan instruction command and the received extension scan instruction command and thus performs scan processing.

### <Scan Processing: Extension Application>

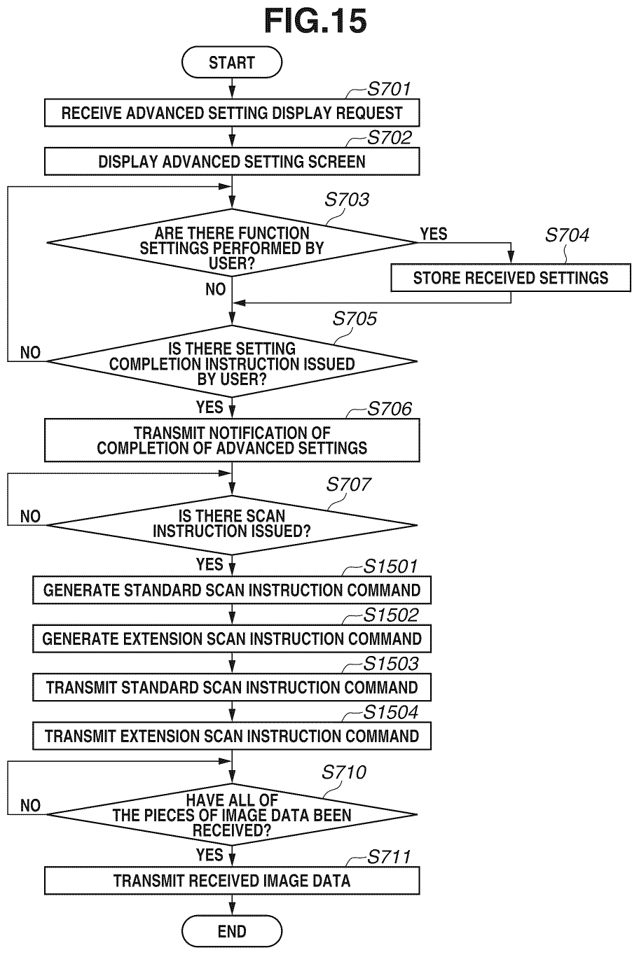

Here, a flowchart of processing which the extension application 204 performs to perform scan processing is described with reference to FIG. 15. Furthermore, steps in the flowchart of FIG. 15 are implemented by the CPU 111 reading out the respective units from the external storage device 114 onto the RAM 113 and executing the respective read-out units.

Steps in common with those illustrated in FIG. 7 are assigned the respective same step numbers as those illustrated in FIG. 7 and are omitted from description here, and differences therebetween are mainly described.

In step S1501, the extension application 204 generates a standard scan instruction command compliant with the standard protocol.

In step S1502, the extension application 204 generates an extension scan instruction command for a function which is not supported by the standard protocol.

In step S1503, the extension application 204 transmits the standard scan instruction command generated in step S1501 to the scanning device 102.

In step S1504, the extension application 204 transmits the extension scan instruction command generated in step S1502 to the scanning device 102.

As described above, in the fourth embodiment, a different scan instruction command is transmitted from the extension application with respect to a function which is not supported by the standard protocol, so that it becomes possible to provide the dropout color function to the user.

### Fifth Embodiment

Next, a fifth embodiment of the present disclosure is described. In the above-described embodiments, the method of designating a color on which to perform dropout color from among preliminarily prepared options has been described.

In the fifth embodiment, a case where designating luminance values of R, G, and B enables performing dropout color processing on a color other than the preliminarily prepared options is described.

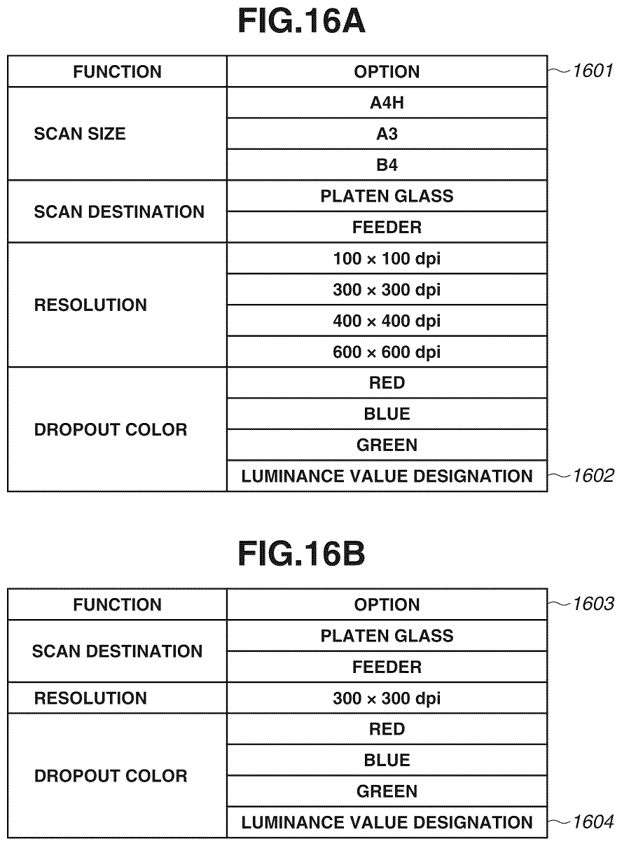

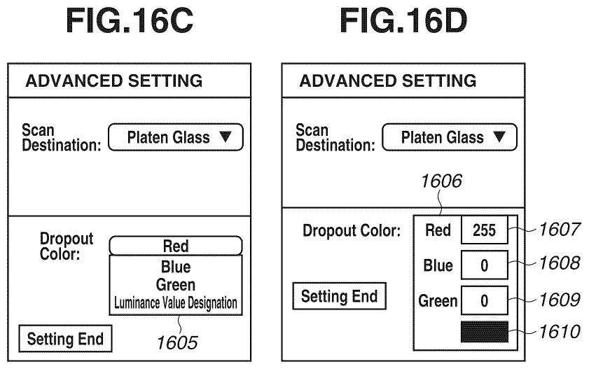

In the following description, only differences from those in the above-described embodiments are described with reference to FIGS. 16A, 16B, 16C, and 16D.

FIG. 16A illustrates, as a table 1601, an example of a list of pieces of capability information acquired from the scanning device 102 in the fifth embodiment. As shown in the table 1601, information indicating that “luminance value designation” (1602) is supported as the dropout color function is obtainable from the scanning device 102. As shown in a table 1603 illustrated in FIG. 16B, it is assumed that the extension application also supports “luminance value designation” as the dropout color function.

FIGS. 16C and 16D illustrate examples of advanced setting screens in which the setting of “luminance value designation” is available. FIG. 16C illustrates an example of the case of displaying “luminance value designation” in a list 1605 as a selection item of dropout color. FIG. 16D illustrates an advanced setting screen which is displayed in a case where the luminance value designation has been set. In a case where the luminance value designation has been set, controls 1607 to 1609, which allow inputting of luminance values of red, blue, and green, respectively, therein, are displayed within a control 1606. Inputting the respective luminance values in the range of 0 to 255 enables designating a color on which to perform dropout color processing. A configuration in which the user is allowed to check the designated color with a sample color 1610 being displayed can be employed. Moreover, while, in the fifth embodiment, the case of inputting values 0 to 255 has been described, the method of allowing the user to designate a color with 10 divided stages can also be employed. Moreover, while the case of displaying the control 1606 in response to “luminance value designation” being selected in the list 1605 has been described, the method of preliminarily displaying the control 1606 and graying out the control 1606 until “luminance value designation” is selected can also be employed.

As described above, in the fifth embodiment, it becomes possible to provide a dropout color function capable of performing designation by inputting luminance values as a color on which to perform dropout color processing.

### Sixth Embodiment

Next, a sixth embodiment of the present disclosure is described.

In the sixth embodiment, the case of performing selection from a hue circle when designating a color on which to perform dropout color processing is described.

Performing selection from a hue circle enables the user to intuitively designate a color on which to perform dropout color processing.

Furthermore, in the following description, only differences from those in the above-described embodiments are described.

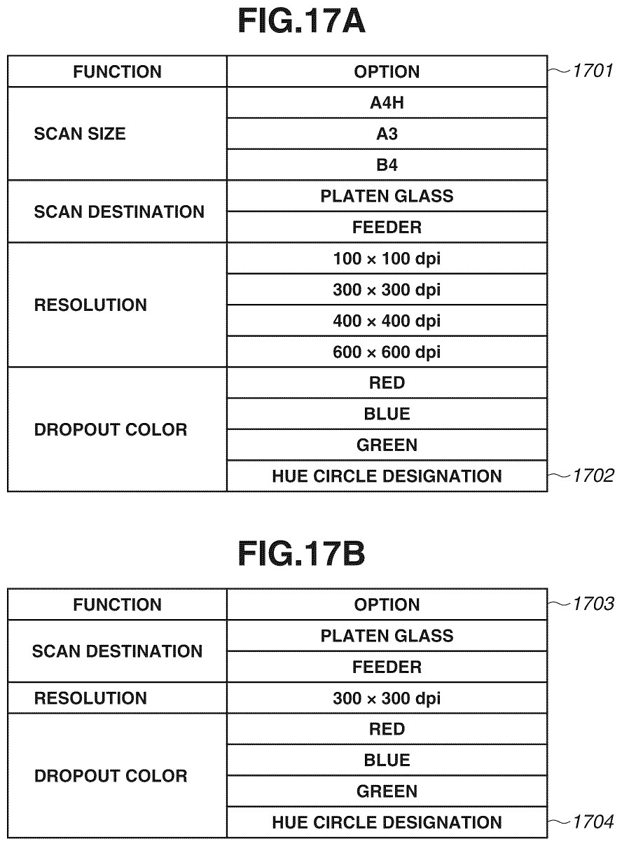

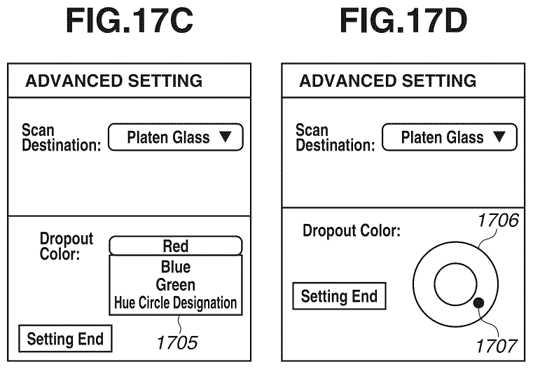

FIG. 17A illustrates, as a table 1701, an example of a list of pieces of capability information acquired from the scanning device 102 in the sixth embodiment. As shown in the table 1701, information indicating that “hue circle designation” 1702 is supported as the dropout color function is obtainable from the scanning device 102. As shown in a table 1703 illustrated in FIG. 17B, it is assumed that the extension application also supports “hue circle designation” as the dropout color function.

FIGS. 17C and 17D illustrate examples of advanced setting screens in which the setting of “hue circle designation” is available. FIG. 17C illustrates an example of the case of displaying “hue circle designation” in a list 1705 as a selection item of dropout color. FIG. 17D illustrates an advanced setting screen which is displayed in a case where the hue circle designation has been set. In a case where the hue circle designation has been set, it becomes possible to select an optional color from a hue circle 1706. The hue circle represents changes of hue on a color space which are expressed in a circular pattern. For example, when the upper portion of the circle is green, the hue changes to yellow, red, purple, blue, light blue, and green in this order clockwise. By operating a control 1707, the user selects a color on which to perform dropout color processing. While the case of displaying the hue circle 1706 and the control 1707 in response to “hue circle designation” being selected in the list 1705 has been described, the method of preliminarily displaying the hue circle 1706 and the control 1707 and graying out the hue circle 1706 and the control 1707 until “hue circle designation” is selected can also be employed.

As described above, in the sixth embodiment, it becomes possible for the user to, when performing dropout color, designate a color from a hue circle.

### Seventh Embodiment

Next, a seventh embodiment of the present disclosure is described.

In the seventh embodiment, a case where, when having designated a color on which to perform dropout color processing from options, the user is able to perform level designation of the color is described.

Being able to perform level designation of the color enables the user to determine the accuracy of dropout color processing.

Furthermore, in the following description, only differences from those in the above-described embodiments are described.

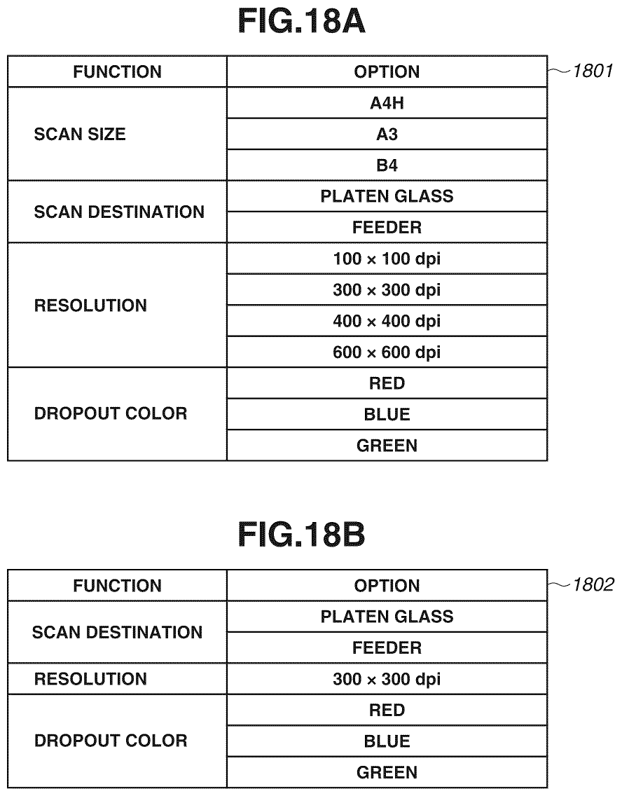

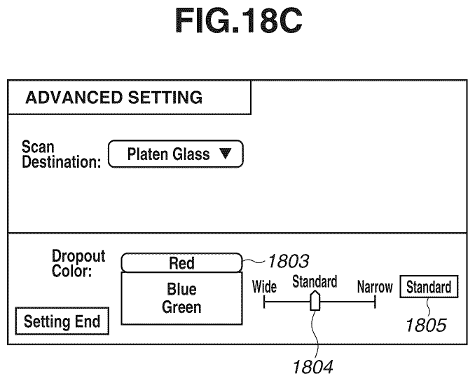

FIG. 18A illustrates, as a table 1801, an example of a list of pieces of capability information acquired from the scanning device 102 in the seventh embodiment. A table 1802 illustrated in FIG. 18B shows a list of pieces of capability information about the extension application.

FIG. 18C illustrates an example of an advanced setting screen available for performing level setting of a color designated in the dropout color processing. In the example illustrated in FIG. 18C, “red” is currently selected in a list 1803 as a selection item in the dropout color processing. Additionally, controls 1804 and 1805 for performing level setting are currently displayed. The control 1804 is a button available for selecting a level for a color on which to perform dropout color processing, and “standard” is currently displayed in the control 1805. The control 1804 indicates that, besides “standard” currently displayed, there are “wide” and “narrow”. If “wide” is selected for red, colors from reddish orange color to purplish red color in addition to red color are set as targets for the dropout color processing. On the other hand, if “narrow” is selected for red, only red color is set as a target for the dropout color processing. While, in the seventh embodiment, a case where, when “wide” is selected, nearby hue colors are set as targets for the dropout color processing has been described, a method in which a nearby color that is based on brightness or saturation is set as a target for the dropout color processing can also be employed. Moreover, while, in the seventh embodiment, a case where level setting is performed with three stages has been described, level setting can also be performed with two stages or with four or more stages. Moreover, while, in the seventh embodiment, expressions such as “wide”, “standard”, and “narrow” are used, levels can also be expressed by numerals or alphabets.

Moreover, while, in the seventh embodiment, a case where, when selecting a color on which to perform dropout color processing, the user designates the color from a list has been described, a configuration in which, even when having designated a hue circle or luminance values, the user is able to perform level setting can also be employed.

As described above, in the seventh embodiment, it becomes possible for the user to, when performing dropout color, designate the level of a color on which to perform dropout color processing.

According to an aspect of the present disclosure, a program for extending the function of universal scan software which is usable in common by respective scan devices which a plurality of manufacturers provides is used to enable the user to use the dropout color function.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-158731 filed Sep. 13, 2024, which is hereby incorporated by reference herein in its entirety.

What is claimed is:

1. A non-transitory computer-readable storage medium storing a program for supporting general-purpose software which is able to be used in common by a plurality of image processing devices manufactured by different manufacturers, wherein the program, when executed by a computer, causes an information processing apparatus to perform a method comprising:
displaying, on a display unit, a display screen to accept a dropout color setting which removes a specific color from an image; and
outputting a read instruction to cause an image processing device to initiate reading of an original image according to the dropout color setting accepted through the display screen.

2. The non-transitory computer-readable storage medium according to claim 1, wherein the specific color is selected from a plurality of color candidates.

3. The non-transitory computer-readable storage medium according to claim 1, wherein the specific color is selected by designating luminance values of red, green, and blue.

4. The non-transitory computer-readable storage medium according to claim 1, wherein the specific color is selected from a hue circle.

5. The non-transitory computer-readable storage medium according to claim 1, wherein the display screen further accepts a level of processing for the dropout color.

6. The non-transitory computer-readable storage medium according to claim 1, wherein an item displayed on the display screen changes based on a reading capability of the image processing device.

7. The non-transitory computer-readable storage medium according to claim 1, the method further comprising:
determining whether reading conforming to the setting of dropout color accepted in the display screen is feasible by an image processing device; and
if it is determined that reading conforming to the setting of dropout color accepted in the display screen is not feasible by the image processing device, performing dropout color processing for image data acquired by reading the original, based on the setting accepted in the display screen.

8. The non-transitory computer-readable storage medium according to claim 7, the method further comprising:
if it is determined that reading conforming to the setting of dropout color accepted in the display screen is not feasible by the image processing device, outputting an instruction command which does not include an instruction for dropout color.

9. The non-transitory computer-readable storage medium according to claim 1, the method further comprising:
transmitting the read instruction to the image processing device via the general-purpose software.

10. The non-transitory computer-readable storage medium according to claim 1, wherein the general-purpose software causes the information processing apparatus to acquire capability information from the image processing device according to Internet Printing Protocol (IPP).

11. A method for supporting general-purpose software that is usable in common by a plurality of image processing devices manufactured by different manufacturers, the method comprising:
displaying a display screen configured to accept a dropout color setting which removes a specific color from an image; and
outputting a read instruction to cause an image processing device to read an original image according to the dropout color setting accepted through the display screen.

12. An information processing apparatus including a program which supports general-purpose software usable in common by a plurality of image processing devices manufactured by different manufacturers, the information processing apparatus comprising:
a display unit configured to display a display screen that allows a user to set a dropout color setting which removes a specific color from an image, by executing the program; and
an output unit configured to output a read instruction to an image processing device to read an original image according to the dropout color setting accepted through the display screen, by executing the program.
